(19) United States
(12) Patent Application Publication
(10) Pub. No.: US 2017/0359827 A1
(43) Pub. Date: Dec. 14, 2017

(54) METHOD FOR INTERFERENCE CONTROL IN RADIO RESOURCE AND DEVICE THEREFOR

(71) Applicant: LG ELECTRONICS INC., Seoul (KR)

(72) Inventors: Kijun KIM, Seoul (KR); Sangwook LEE, Seoul (KR); Yunjung YI, Seoul (KR)

(73) Assignee: LG ELECTRONICS INC., Seoul (KR)

(21) Appl. No.: 15/524,237

(22) PCT Filed: Nov. 26, 2015
(86) PCT No.: PCT/KR2015/012763

§ 371 Date: May 3, 2017

Related U.S. Application Data
(60) Provisional application No. 62/086,666, filed on Dec. 2, 2014.

(51) Int. Cl. H04W 72/08; H04L 5/00; H04L 1/18; H04W 72/04; H04W 72/12

(52) U.S. Cl. CPC H04W 72/082; H04W 72/048; H04W 72/1284; H04L 1/1887; H04L 5/0073; H04W 72/0446; H04W 72/0453

(57) ABSTRACT

According to one embodiment of the present invention, a method for interference control in a radio resource having a plurality of bands and a plurality of frames comprises the steps of: allocating a dedicated data channel for a specific terminal and a common data channel for a plurality of terminals; and transmitting, to a neighboring base station, information related to the allocated dedicated data channel and common data channel, wherein the dedicated data channel can be allocated when data, to be transmitted to the specific terminal standing by in a transmission buffer, is larger than a predetermined amount.

### TECHNICAL FIELD

The present invention relates to a wireless communication system, and more particularly, to a method of controlling interference in a radio resource and an apparatus therefor.

### BACKGROUND ART

Recently, various devices requiring machine-to-machine (M2M) communication and high data transfer rate, such as smartphones or tablet personal computers (PCs), have appeared and come into widespread use. This has rapidly increased the quantity of data which needs to be processed in a cellular network. In order to satisfy such rapidly increasing data throughput, recently, carrier aggregation (CA) technology which efficiently uses more frequency bands, cognitive ratio technology, multiple antenna (MIMO) technology for increasing data capacity in a restricted frequency, multiple-base-station cooperative technology, etc. have been highlighted. In addition, communication environments have evolved such that the density of accessible nodes is increased in the vicinity of a user equipment (UE). Here, the node includes one or more antennas and refers to a fixed point capable of transmitting/receiving radio frequency (RF) signals to/from the user equipment (UE). A communication system including high-density nodes may provide a communication service of higher performance to the UE by cooperation between nodes.

A multi-node coordinated communication scheme in which a plurality of nodes communicates with a user equipment (UE) using the same time-frequency resources has much higher data throughput than legacy communication scheme in which each node operates as an independent base station (BS) to communicate with the UE without cooperation.

A multi-node system performs coordinated communication using a plurality of nodes, each of which operates as a base station or an access point, an antenna, an antenna group, a remote radio head (RRH), and a remote radio unit (RRU). Unlike the conventional centralized antenna system in which antennas are concentrated at a base station (BS), nodes are spaced apart from each other by a predetermined distance or more in the multi-node system. The nodes can be managed by one or more base stations or base station controllers which control operations of the nodes or schedule data transmitted/received through the nodes. Each node is connected to a base station or a base station controller which manages the node through a cable or a dedicated line.

The multi-node system can be considered as a kind of Multiple Input Multiple Output (MIMO) system since dispersed nodes can communicate with a single UE or multiple UEs by simultaneously transmitting/receiving different data streams. However, since the multi-node system transmits signals using the dispersed nodes, a transmission area covered by each antenna is reduced compared to antennas included in the conventional centralized antenna system. Accordingly, transmit power required for each antenna to transmit a signal in the multi-node system can be reduced compared to the conventional centralized antenna system using MIMO. In addition, a transmission distance between an antenna and a UE is reduced to decrease in pathloss and enable rapid data transmission in the multi-node system. This can improve transmission capacity and power efficiency of a cellular system and meet communication performance having relatively uniform quality regardless of UE locations in a cell. Further, the multi-node system reduces signal loss generated during transmission since base station(s) or base station controller(s) connected to a plurality of nodes transmit/receive data in cooperation with each other. When nodes spaced apart by over a predetermined distance perform coordinated communication with a UE, correlation and interference between antennas are reduced. Therefore, a high signal to interference-plus-noise ratio (SINR) can be obtained according to the multi-node coordinated communication scheme.

Owing to the above-mentioned advantages of the multi-node system, the multi-node system is used with or replaces the conventional centralized antenna system to become a new foundation of cellular communication in order to reduce base station cost and backhaul network maintenance cost while extending service coverage and improving channel capacity and SINR in next-generation mobile communication systems.

### DISCLOSURE OF THE INVENTION

### Technical Task

An object of the present invention is to provide a method of controlling interference in a radio resource in a wireless communication system.

Technical tasks obtainable from the present invention are non-limited the above-mentioned technical task. And, other unmentioned technical tasks can be clearly understood from the following description by those having ordinary skill in the technical field to which the present invention pertains.

### Technical Solution

To achieve these and other advantages and in accordance with the purpose of the present invention, as embodied and broadly described, according to one embodiment, a method of controlling interference in a radio resource including a plurality of bands and a plurality of frames, includes the steps of allocating a dedicated data channel for a specific terminal and a common data channel for a plurality of terminals, and forwarding information on the allocated dedicated data channel and the common data channel to a neighboring base station. In this case, the dedicated data channel may be allocated when an amount of data to be transmitted to the specific terminal, which is waiting in a transmission buffer, is greater than a predetermined amount.

Additionally or alternately, the information on the dedicated data channel may include the number of the dedicated data channel, the number of subchannels included in each dedicated data channel, and a resource position of each dedicated data subchannel.

Additionally or alternately, the information on the dedicated data channel may include the number of subchannels included in a feedback channel or a grant channel linked with each dedicated data channel and a resource position of each dedicated feedback subchannel.

Additionally or alternately, the number of HARQ (hybrid automatic request transmission) processes of the dedicated data channel may be determined according to a time interval between the dedicated data channel and the feedback channel or the grant channel linked with the dedicated data channel.

Additionally or alternately, a transmission interval of the dedicated data channel may be determined according to a time interval between the dedicated data channel and the feedback channel or the grant channel linked with the dedicated data channel.

Additionally or alternately, a plurality of feedback channels or grant channels associated with a plurality of dedicated data channels may be multiplexed and allocated to a single subchannel.

Additionally or alternately, the method may include forwarding, to the neighboring base station, information on an use priority of a plurality of sub-regions contained in the dedicated data channel. In this case, the dedicated data channel may be allocated according to the use priority.

Additionally or alternately, the method may include the step of receiving information on a dedicated data channel and a common data channel allocated for terminals of the neighboring base station from the neighboring base station.

Additionally or alternately, the dedicated data channel for the specific terminal and the common data channel for the plurality of the terminals may be allocated based on information on a dedicated data channel and a common data channel allocated for terminals of the neighboring base station received from the neighboring base station.

To further achieve these and other advantages and in accordance with the purpose of the present invention, according to a different embodiment, a base station configured to control interference in a radio resource including a plurality of bands and a plurality of frames includes an RF (radio frequency) unit, and a processor configured to control the RF unit, the processor configured to allocate a dedicated data channel for a specific terminal and a common data channel for a plurality of terminals, the processor configured to forward information on the allocated dedicated data channel and the common data channel to a neighboring base station. In this case, the dedicated data channel may be allocated when an amount of data to be transmitted to the specific terminal, which is waiting in a transmission buffer, is greater than a predetermined amount.

Additionally or alternately, the information on the dedicated data channel may include the number of the dedicated data channel, the number of subchannels included in each dedicated data channel, and a resource position of each dedicated data subchannel.

Additionally or alternately, the information on the dedicated data channel may include the number of subchannels included in a feedback channel or a grant channel linked with each dedicated data channel and a resource position of each dedicated feedback subchannel.

Additionally or alternately, the number of HARQ (hybrid automatic request transmission) processes of the dedicated data channel may be determined according to a time interval between the dedicated data channel and the feedback channel or the grant channel linked with the dedicated data channel.

Additionally or alternately, a transmission interval of the dedicated data channel may be determined according to a time interval between the dedicated data channel and the feedback channel or a grant channel associated with the dedicated data channel.

Additionally or alternately, a plurality of feedback channels or grant channels associated with a plurality of dedicated data channels may be multiplexed and allocated to a single subchannel.

Additionally or alternately, the processor may be configured to forward information on an use priority of a plurality of sub-regions contained in the dedicated data channel to the neighboring base station and the dedicated data channel can be allocated according to the use priority.

Additionally or alternately, the processor may be configured to receive information on a dedicated data channel and a common data channel allocated for terminals of the neighboring base station from the neighboring base station.

Additionally or alternately, the dedicated data channel allocated for the specific terminal and the common data channel allocated for a plurality of the terminals may be allocated based on information on a dedicated data channel and a common data channel allocated for terminals of the neighboring base station received from the neighboring base station.

It is to be understood that both the foregoing general description and the following detailed description are exemplary and explanatory and are intended to provide further explanation of the invention as claimed.

### Advantageous Effects

According to one embodiment of the present invention, it is able to more efficiently perform wireless communication via interference control.

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a diagram for an example of a radio frame structure used in a wireless communication system;

FIG. 2 is a diagram for an example of a downlink (DL)/uplink (UL) slot structure in a wireless communication system;

FIG. 3 is a diagram for an example of a downlink (DL) subframe structure used in 3GPP LTE/LTE-A system;

FIG. 4 is a diagram for an example of an uplink (UL) subframe structure used in 3GPP LTE/LTE-A system;

FIG. 5 is a diagram for subchannels allocated in a radio resource according to one embodiment of the present invention;

FIG. 6 is a diagram for data channels and feedback channels allocated in a radio resource according to one embodiment of the present invention;

FIG. 7 is a diagram for data channels and feedback channels allocated in a radio resource according to one embodiment of the present invention;

FIG. 8 is a diagram for data channels and feedback channels allocated in a radio resource according to one embodiment of the present invention;

FIG. 9 is a diagram for data channels and regions to which feedback channels connected with the data channels are capable of being allocated in a radio resource according to one embodiment of the present invention;

FIG. 10 is a diagram for a plurality of data channels and multiplexed feedback channels connected with a plurality of the data channels allocated in a radio resource according to one embodiment of the present invention;

FIG. 11 is a diagram for data channels and feedback channels allocated in a radio resource according to one embodiment of the present invention;

FIG. 12 is a diagram for data channels and feedback channels allocated in a radio resource according to one embodiment of the present invention;

FIG. 13 is a diagram for grant channels and uplink data channels according to the grant channels allocated in a radio resource according to one embodiment of the present invention;

FIG. 14 is a diagram for grant channels and regions to which uplink data channels connected with the grant channels are capable of being allocated in a radio resource according to one embodiment of the present invention;

FIG. 15 is a diagram for multiplexed grant channels and uplink data channels according to the grant channels allocated in a radio resource according to one embodiment of the present invention;

FIG. 16 is a diagram for grant channels and uplink data channels according to the grant channels allocated in a radio resource according to one embodiment of the present invention;

FIG. 17 is a diagram for uplink/downlink dedicated data channels and common data channels allocated in a radio resource according to one embodiment of the present invention;

FIG. 18 is a flowchart for an operation according to one embodiment of the present invention;

FIG. 19 is a block diagram of devices for implementing embodiment(s) of the present invention.

### BEST MODE

### Mode for Invention

Reference will now be made in detail to the preferred embodiments of the present invention, examples of which are illustrated in the accompanying drawings. The accompanying drawings illustrate exemplary embodiments of the present invention and provide a more detailed description of the present invention. However, the scope of the present invention should not be limited thereto.

In some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

In the present invention, a user equipment (UE) is fixed or mobile. The UE is a device that transmits and receives user data and/or control information by communicating with a base station (BS). The term ‘UE’ may be replaced with ‘terminal equipment’, ‘Mobile Station (MS)’, ‘Mobile Terminal (MT)’, ‘User Terminal (UT)’, ‘Subscriber Station (SS)’, ‘wireless device’, ‘Personal Digital Assistant (PDA)’, ‘wireless modem’, ‘handheld device’, etc. A BS is typically a fixed station that communicates with a UE and/or another BS. The BS exchanges data and control information with a UE and another BS. The term ‘BS’ may be replaced with ‘Advanced Base Station (ABS)’, ‘Node B’, ‘evolved-Node B (eNB)’, ‘Base Transceiver System (BTS)’, ‘Access Point (AP)’, ‘Processing Server (PS)’, etc. In the following description, BS is commonly called eNB.

In the present invention, a node refers to a fixed point capable of transmitting/receiving a radio signal to/from a UE by communication with the UE. Various eNBs can be used as nodes. For example, a node can be a BS, NB, eNB, pico-cell eNB (PeNB), home eNB (HeNB), relay, repeater, etc. Furthermore, a node may not be an eNB. For example, a node can be a radio remote head (RRH) or a radio remote unit (RRU). The RRH and RRU have power levels lower than that of the eNB. Since the RRH or RRU (referred to as RRH/RRU hereinafter) is connected to an eNB through a dedicated line such as an optical cable in general, cooperative communication according to RRH/RRU and eNB can be smoothly performed compared to cooperative communication according to eNBs connected through a wireless link. At least one antenna is installed per node. An antenna may refer to an antenna port, a virtual antenna or an antenna group. A node may also be called a point. Unlink a conventional centralized antenna system (CAS) (i.e. single node system) in which antennas are concentrated in an eNB and controlled an eNB controller, plural nodes are spaced apart at a predetermined distance or longer in a multi-node system. The plural nodes can be managed by one or more eNBs or eNB controllers that control operations of the nodes or schedule data to be transmitted/received through the nodes. Each node may be connected to an eNB or eNB controller managing the corresponding node via a cable or a dedicated line. In the multi-node system, the same cell identity (ID) or different cell IDs may be used for signal transmission/reception through plural nodes. When plural nodes have the same cell ID, each of the plural nodes operates as an antenna group of a cell. If nodes have different cell IDs in the multi-node system, the multi-node system can be regarded as a multi-cell (e.g., macro-cell/femto-cell/pico-cell) system. When multiple cells respectively configured by plural nodes are overlaid according to coverage, a network configured by multiple cells is called a multi-tier network. The cell ID of the RRH/RRU may be identical to or different from the cell ID of an eNB. When the RRH/RRU and eNB use different cell IDs, both the RRH/RRU and eNB operate as independent eNBs.

In a multi-node system according to the present invention, which will be described below, one or more eNBs or eNB controllers connected to plural nodes can control the plural nodes such that signals are simultaneously transmitted to or received from a UE through some or all nodes. While there is a difference between multi-node systems according to the nature of each node and implementation form of each node, multi-node systems are discriminated from single node systems (e.g. CAS, conventional MIMO systems, conventional relay systems, conventional repeater systems, etc.) since a plurality of nodes provides communication services to a UE in a predetermined time-frequency resource. Accordingly, embodiments of the present invention with respect to a method of performing coordinated data transmission using some or all nodes can be applied to various types of multi-node systems. For example, a node refers to an antenna group spaced apart from another node by a predetermined distance or more, in general. However, embodiments of the present invention, which will be described below, can even be applied to a case in which a node refers to an arbitrary antenna group irrespective of node interval. In the case of an eNB including an X-pole (cross polarized) antenna, for example, the embodiments of the preset invention are applicable on the assumption that the eNB controls a node composed of an H-pole antenna and a V-pole antenna.

A communication scheme through which signals are transmitted/received via plural transmit (Tx)/receive (Rx) nodes, signals are transmitted/received via at least one node selected from plural Tx/Rx nodes, or a node transmitting a downlink signal is discriminated from a node transmitting an uplink signal is called multi-eNB MIMO or CoMP (Coordinated Multi-Point Tx/Rx). Coordinated transmission schemes from among CoMP communication schemes can be categorized into JP (Joint Processing) and scheduling coordination. The former may be divided into JT (Joint Transmission)/JR (Joint Reception) and DPS (Dynamic Point Selection) and the latter may be divided into CS (Coordinated Scheduling) and CB (Coordinated Beamforming). DPS may be called DCS (Dynamic Cell Selection). When JP is performed, more various communication environments can be generated, compared to other CoMP schemes. JT refers to a communication scheme by which plural nodes transmit the same stream to a UE and JR refers to a communication scheme by which plural nodes receive the same stream from the UE. The UE/eNB combine signals received from the plural nodes to restore the stream. In the case of JT/JR, signal transmission reliability can be improved according to transmit diversity since the same stream is transmitted from/to plural nodes. DPS refers to a communication scheme by which a signal is transmitted/received through a node selected from plural nodes according to a specific rule. In the case of DPS, signal transmission reliability can be improved because a node having a good channel state between the node and a UE is selected as a communication node.

In the present invention, a cell refers to a specific geographical area in which one or more nodes provide communication services. Accordingly, communication with a specific cell may mean communication with an eNB or a node providing communication services to the specific cell. A downlink/uplink signal of a specific cell refers to a downlink/uplink signal from/to an eNB or a node providing communication services to the specific cell. A cell providing uplink/downlink communication services to a UE is called a serving cell. Furthermore, channel status/quality of a specific cell refers to channel status/quality of a channel or a communication link generated between an eNB or a node providing communication services to the specific cell and a UE. In 3GPP LTE-A systems, a UE can measure downlink channel state from a specific node using one or more CSI-RSs (Channel State Information Reference Signals) transmitted through antenna port(s) of the specific node on a CSI-RS resource allocated to the specific node. In general, neighboring nodes transmit CSI-RS resources on orthogonal CSI-RS resources. When CSI-RS resources are orthogonal, this means that the CSI-RS resources have different subframe configurations and/or CSI-RS sequences which specify subframes to which CSI-RSs are allocated according to CSI-RS resource configurations, subframe offsets and transmission periods, etc. which specify symbols and subcarriers carrying the CSI RSs.

In the present invention, PDCCH (Physical Downlink Control Channel)/PCFICH (Physical Control Format Indicator Channel)/PHICH (Physical Hybrid automatic repeat request Indicator Channel)/PDSCH (Physical Downlink Shared Channel) refer to a set of time-frequency resources or resource elements respectively carrying DCI (Downlink Control Information)/CFI (Control Format Indicator)/downlink ACK/NACK (Acknowledgement/Negative ACK)/downlink data. In addition, PUCCH (Physical Uplink Control Channel)/PUSCH (Physical Uplink Shared Channel)/PRACH (Physical Random Access Channel) refer to sets of time-frequency resources or resource elements respectively carrying UCI (Uplink Control Information)/uplink data/random access signals. In the present invention, a time-frequency resource or a resource element (RE), which is allocated to or belongs to PDCCH/PCFICH/PHICH/PDSCH/PUCCH/PUSCH/PRACH, is referred to as a PDCCH/PCFICH/PHICH/PDSCH/PUCCH/PUSCH/PRACH RE or PDCCH/PCFICH/PHICH/PDSCH/PUCCH/PUSCH/PRACH resource. In the following description, transmission of PUCCH/PUSCH/PRACH by a UE is equivalent to transmission of uplink control information/uplink data/random access signal through or on PUCCH/PUSCH/PRACH. Furthermore, transmission of PDCCH/PCFICH/PHICH/PDSCH by an eNB is equivalent to transmission of downlink data/control information through or on PDCCH/PCFICH/PHICH/PDSCH.

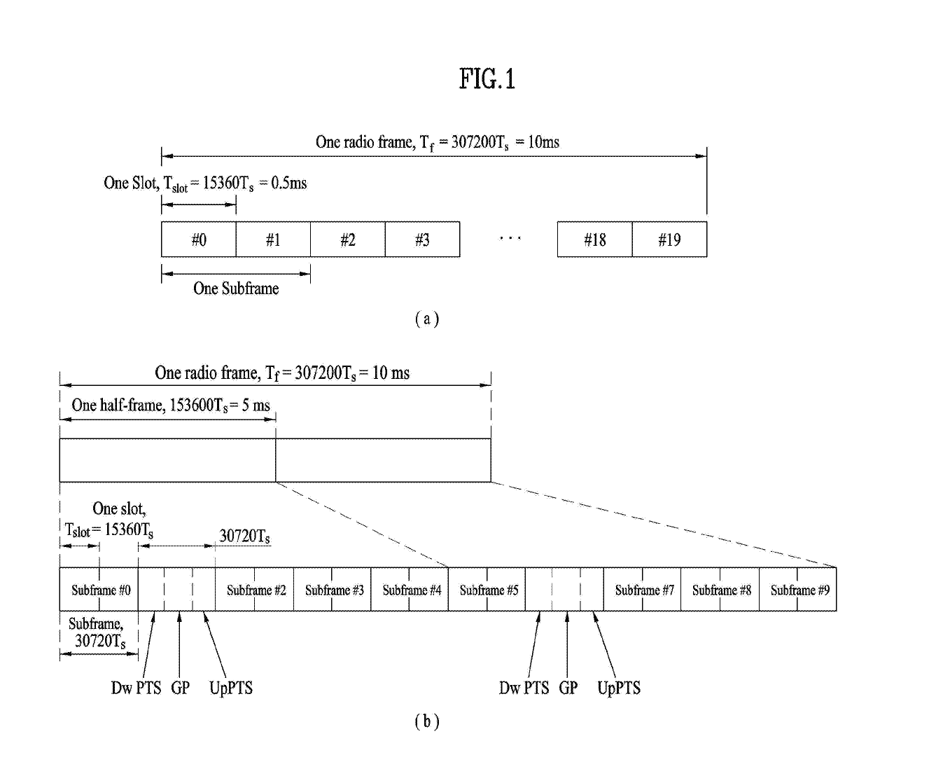

FIGS. 1A and 1B illustrate an exemplary radio frame structure used in a wireless communication system. FIG. 1A illustrates a frame structure for frequency division duplex (FDD) used in 3GPP LTE/LTE-A and FIG. 1B illustrates a frame structure for time division duplex (TDD) used in 3GPP LTE/LTE-A.

Referring to FIG. 1A, a radio frame used in 3GPP LTE/LTE-A has a length of 10 ms (307200 Ts) and includes 10 subframes in equal size. The 10 subframes in the radio frame may be numbered. Here, Ts denotes sampling time and is represented as Ts=1/(2048*15 kHz). Each subframe has a length of 1 ms and includes two slots. 20 slots in the radio frame can be sequentially numbered from 0 to 19. Each slot has a length of 0.5 ms. A time for transmitting a subframe is defined as a transmission time interval (TTI). Time resources can be discriminated by a radio frame number (or radio frame index), subframe number (or subframe index) and a slot number (or slot index).

The radio frame can be configured differently according to duplex mode. Downlink transmission is discriminated from uplink transmission by frequency in FDD mode, and thus the radio frame includes only one of a downlink subframe and an uplink subframe in a specific frequency band. In TDD mode, downlink transmission is discriminated from uplink transmission by time, and thus the radio frame includes both a downlink subframe and an uplink subframe in a specific frequency band.

Table 1 shows DL-UL configurations of subframes in a radio frame in the TDD mode.

TABLE 1

| | Downlink- | | | | | | | | | | |
|---|---|---|---|---|---|---|---|---|---|---|---|
| | to-Uplink | | | | | | | | | | |
| | Switch- | | | | | | | | | | |
| DL-UL | point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1, D denotes a downlink subframe, U denotes an uplink subframe and S denotes a special subframe. The special subframe includes three fields of DwPTS (Downlink Pilot TimeSlot), GP (Guard Period), and UpPTS (Uplink Pilot TimeSlot). DwPTS is a period reserved for downlink transmission and UpPTS is a period reserved for uplink transmission. Table 2 shows special subframe configuration.

TABLE 2

| | Normal cyclic prefix in downlink | | | Extended cyclic prefix in downlink | | |
|---|---|---|---|---|---|---|
| | | UpPTS | | | UpPTS | |
| Special | | Normal cyclic | Extended | | Normal | Extended |
| subframe | | prefix in | cyclic prefix | | cyclic prefix | cyclic prefix |
| configuration | DwPTS | uplink | in uplink | DwPTS | in uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | 12800 · Tₛ | | |
| 8 | 24144 · Tₛ | | | — | — | — |
| 9 | 13168 · Tₛ | | | — | — | — |

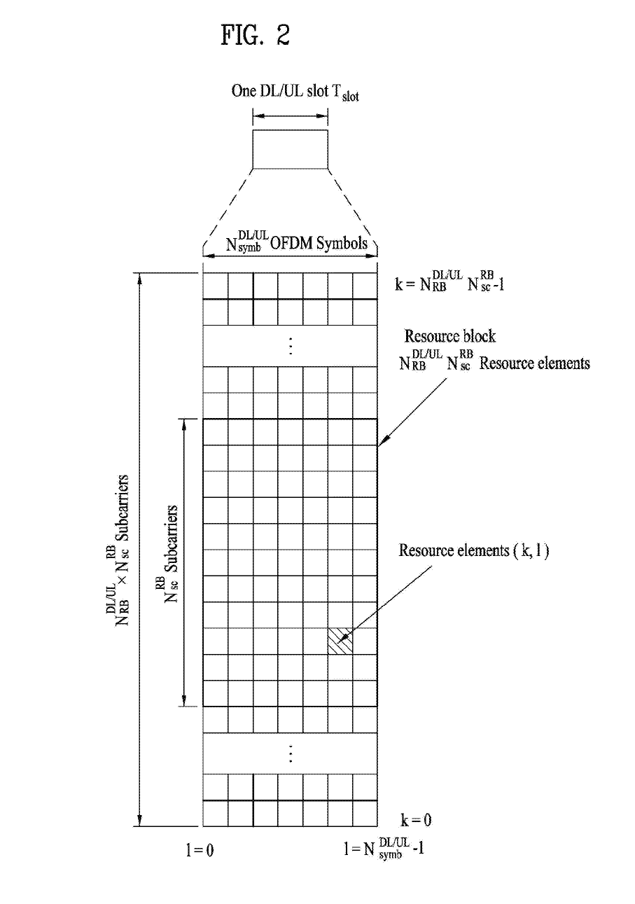

FIG. 2 illustrates an exemplary downlink/uplink slot structure in a wireless communication system. Particularly, FIG. 2 illustrates a resource grid structure in 3GPP LTE/LTE-A. A resource grid is present per antenna port.

Referring to FIG. 2, a slot includes a plurality of OFDM (Orthogonal Frequency Division Multiplexing) symbols in the time domain and a plurality of resource blocks (RBs) in the frequency domain. An OFDM symbol may refer to a symbol period. A signal transmitted in each slot may be represented by a resource grid composed of N_{RB}^{DL/UL}*N_{sc}^{RB} subcarriers and N_{symb}^{DL/UL} OFDM symbols. Here, N_{RB}^{DL} denotes the number of RBs in a downlink slot and N_{RB}^{UL} denotes the number of RBs in an uplink slot. N_{RB}^{DL} and N_{RB}^{UL} respectively depend on a DL transmission bandwidth and a UL transmission bandwidth. N_{symb}^{DL} denotes the number of OFDM symbols in the downlink slot and N_{symb}^{UL} denotes the number of OFDM symbols in the uplink slot. In addition, N_{sc}^{RB} denotes the number of subcarriers constructing one RB.

An OFDM symbol may be called an SC-FDM (Single Carrier Frequency Division Multiplexing) symbol according to multiple access scheme. The number of OFDM symbols included in a slot may depend on a channel bandwidth and the length of a cyclic prefix (CP). For example, a slot includes 7 OFDM symbols in the case of normal CP and 6 OFDM symbols in the case of extended CP. While FIG. 2 illustrates a subframe in which a slot includes 7 OFDM symbols for convenience, embodiments of the present invention can be equally applied to subframes having different numbers of OFDM symbols. Referring to FIG. 2, each OFDM symbol includes N_{RB}^{DL/UL}*N_{sc}^{RB} subcarriers in the frequency domain. Subcarrier types can be classified into a data subcarrier for data transmission, a reference signal subcarrier for reference signal transmission, and null subcarriers for a guard band and a direct current (DC) component. The null subcarrier for a DC component is a subcarrier remaining unused and is mapped to a carrier frequency (f0) during OFDM signal generation or frequency up-conversion. The carrier frequency is also called a center frequency.

An RB is defined by N_{symb}^{DL/UL} (e.g., 7) consecutive OFDM symbols in the time domain and N_{sc}^{RB} (e.g., 12) consecutive subcarriers in the frequency domain. For reference, a resource composed by an OFDM symbol and a subcarrier is called a resource element (RE) or a tone. Accordingly, an RB is composed of N_{symb}^{DL/UL}*N_{sc}^{RB} REs. Each RE in a resource grid can be uniquely defined by an index pair (k, 1) in a slot. Here, k is an index in the range of 0 to N_{symb}^{DL/UL}*N_{sc}^{RB}−1 in the frequency domain and 1 is an index in the range of 0 to N_{symb}^{DL/UL}−1.

Two RBs that occupy N_{sc}^{RB} consecutive subcarriers in a subframe and respectively disposed in two slots of the subframe are called a physical resource block (PRB) pair. Two RBs constituting a PRB pair have the same PRB number (or PRB index). A virtual resource block (VRB) is a logical resource allocation unit for resource allocation. The VRB has the same size as that of the PRB. The VRB may be divided into a localized VRB and a distributed VRB depending on a mapping scheme of VRB into PRB. The localized VRBs are mapped into the PRBs, whereby VRB number (VRB index) corresponds to PRB number. That is, nPRB=nVRB is obtained. Numbers are given to the localized VRBs from 0 to N_{VRB}^{DL}−1, and N_{VRB}^{DL}=N_{RB}^{DL} is obtained. Accordingly, according to the localized mapping scheme, the VRBs having the same VRB number are mapped into the PRBs having the same PRB number at the first slot and the second slot. On the other hand, the distributed VRBs are mapped into the PRBs through interleaving. Accordingly, the VRBs having the same VRB number may be mapped into the PRBs having different PRB numbers at the first slot and the second slot. Two PRBs, which are respectively located at two slots of the subframe and have the same VRB number, will be referred to as a pair of VRBs.

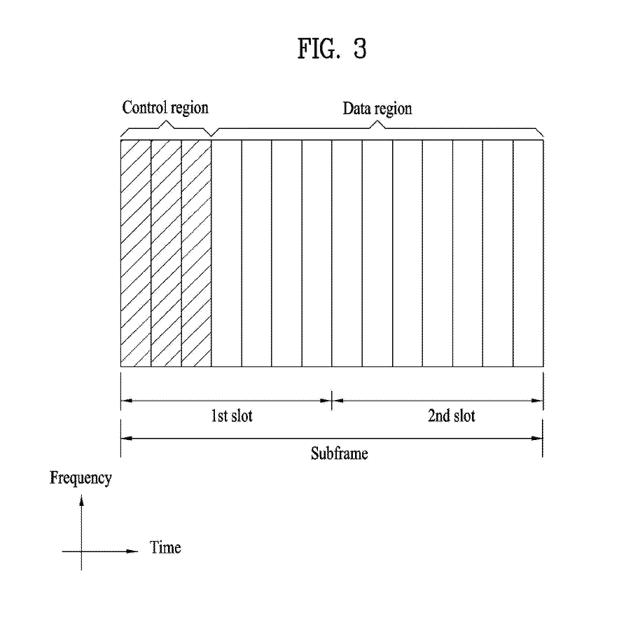

FIG. 3 illustrates a downlink (DL) subframe structure used in 3GPP LTE/LTE-A.

Referring to FIG. 3, a DL subframe is divided into a control region and a data region. A maximum of three (four) OFDM symbols located in a front portion of a first slot within a subframe correspond to the control region to which a control channel is allocated. A resource region available for PDCCH transmission in the DL subframe is referred to as a PDCCH region hereinafter. The remaining OFDM symbols correspond to the data region to which a physical downlink shared chancel (PDSCH) is allocated. A resource region available for PDSCH transmission in the DL subframe is referred to as a PDSCH region hereinafter. Examples of downlink control channels used in 3GPP LTE include a physical control format indicator channel (PCFICH), a physical downlink control channel (PDCCH), a physical hybrid ARQ indicator channel (PHICH), etc. The PCFICH is transmitted at a first OFDM symbol of a subframe and carries information regarding the number of OFDM symbols used for transmission of control channels within the subframe. The PHICH is a response of uplink transmission and carries an HARQ acknowledgment (ACK)/negative acknowledgment (NACK) signal.

Control information carried on the PDCCH is called downlink control information (DCI). The DCI contains resource allocation information and control information for a UE or a UE group. For example, the DCI includes a transport format and resource allocation information of a downlink shared channel (DL-SCH), a transport format and resource allocation information of an uplink shared channel (UL-SCH), paging information of a paging channel (PCH), system information on the DL-SCH, information about resource allocation of an upper layer control message such as a random access response transmitted on the PDSCH, a transmit control command set with respect to individual UEs in a UE group, a transmit power control command, information on activation of a voice over IP (VoIP), downlink assignment index (DAI), etc. The transport format and resource allocation information of the DL-SCH are also called DL scheduling information or a DL grant and the transport format and resource allocation information of the UL-SCH are also called UL scheduling information or a UL grant. The size and purpose of DCI carried on a PDCCH depend on DCI format and the size thereof may be varied according to coding rate. Various formats, for example, formats 0 and 4 for uplink and formats 1, 1A, 1B, 1C, 1D, 2, 2A, 2B, 2C, 3 and 3A for downlink, have been defined in 3GPP LTE. Control information such as a hopping flag, information on RB allocation, modulation coding scheme (MCS), redundancy version (RV), new data indicator (NDI), information on transmit power control (TPC), cyclic shift demodulation reference signal (DMRS), UL index, channel quality information (CQI) request, DL assignment index, HARQ process number, transmitted precoding matrix indicator (TPMI), precoding matrix indicator (PMI), etc. is selected and combined based on DCI format and transmitted to a UE as DCI.

In general, a DCI format for a UE depends on transmission mode (TM) set for the UE. In other words, only a DCI format corresponding to a specific TM can be used for a UE configured in the specific TM.

A PDCCH is transmitted on an aggregation of one or several consecutive control channel elements (CCEs). The CCE is a logical allocation unit used to provide the PDCCH with a coding rate based on a state of a radio channel. The CCE corresponds to a plurality of resource element groups (REGs). For example, a CCE corresponds to 9 REGs and an REG corresponds to 4 REs. 3GPP LTE defines a CCE set in which a PDCCH can be located for each UE. A CCE set from which a UE can detect a PDCCH thereof is called a PDCCH search space, simply, search space. An individual resource through which the PDCCH can be transmitted within the search space is called a PDCCH candidate. A set of PDCCH candidates to be monitored by the UE is defined as the search space. In 3GPP LTE/LTE-A, search spaces for DCI formats may have different sizes and include a dedicated search space and a common search space. The dedicated search space is a UE-specific search space and is configured for each UE. The common search space is configured for a plurality of UEs. Aggregation levels defining the search space is as follows.

TABLE 3

| Search Space | | | |
|---|---|---|---|
| | Aggregation | Size [in | Number of PDCCH |
| Type | Level L | CCEs] | candidates M^{(L)} |
| UE-specific | 1 | 6 | 6 |
| | 2 | 12 | 6 |
| | 4 | 8 | 2 |
| | 8 | 16 | 2 |
| Common | 4 | 16 | 4 |
| | 8 | 16 | 2 |

A PDCCH candidate corresponds to 1, 2, 4 or 8 CCEs according to CCE aggregation level. An eNB transmits a PDCCH (DCI) on an arbitrary PDCCH candidate with in a search space and a UE monitors the search space to detect the PDCCH (DCI). Here, monitoring refers to attempting to decode each PDCCH in the corresponding search space according to all monitored DCI formats. The UE can detect the PDCCH thereof by monitoring plural PDCCHs. Since the UE does not know the position in which the PDCCH thereof is transmitted, the UE attempts to decode all PDCCHs of the corresponding DCI format for each subframe until a PDCCH having the ID thereof is detected. This process is called blind detection (or blind decoding (BD)).

The eNB can transmit data for a UE or a UE group through the data region. Data transmitted through the data region may be called user data. For transmission of the user data, a physical downlink shared channel (PDSCH) may be allocated to the data region. A paging channel (PCH) and downlink-shared channel (DL-SCH) are transmitted through the PDSCH. The UE can read data transmitted through the PDSCH by decoding control information transmitted through a PDCCH. Information representing a UE or a UE group to which data on the PDSCH is transmitted, how the UE or UE group receives and decodes the PDSCH data, etc. is included in the PDCCH and transmitted. For example, if a specific PDCCH is CRC (cyclic redundancy check)-masked having radio network temporary identify (RNTI) of “A” and information about data transmitted using a radio resource (e.g., frequency position) of “B” and transmission format information (e.g., transport block size, modulation scheme, coding information, etc.) of “C” is transmitted through a specific DL subframe, the UE monitors PDCCHs using RNTI information and a UE having the RNTI of “A” detects a PDCCH and receives a PDSCH indicated by “B” and “C” using information about the PDCCH.

A reference signal (RS) to be compared with a data signal is necessary for the UE to demodulate a signal received from the eNB. A reference signal refers to a predetermined signal having a specific waveform, which is transmitted from the eNB to the UE or from the UE to the eNB and known to both the eNB and UE. The reference signal is also called a pilot. Reference signals are categorized into a cell-specific RS shared by all UEs in a cell and a modulation RS (DM RS) dedicated for a specific UE. A DM RS transmitted by the eNB for demodulation of downlink data for a specific UE is called a UE-specific RS. Both or one of DM RS and CRS may be transmitted on downlink. When only the DM RS is transmitted without CRS, an RS for channel measurement needs to be additionally provided because the DM RS transmitted using the same precoder as used for data can be used for demodulation only. For example, in 3GPP LTE(-A), CSI-RS corresponding to an additional RS for measurement is transmitted to the UE such that the UE can measure channel state information. CSI-RS is transmitted in each transmission period corresponding to a plurality of subframes based on the fact that channel state variation with time is not large, unlike CRS transmitted per subframe.

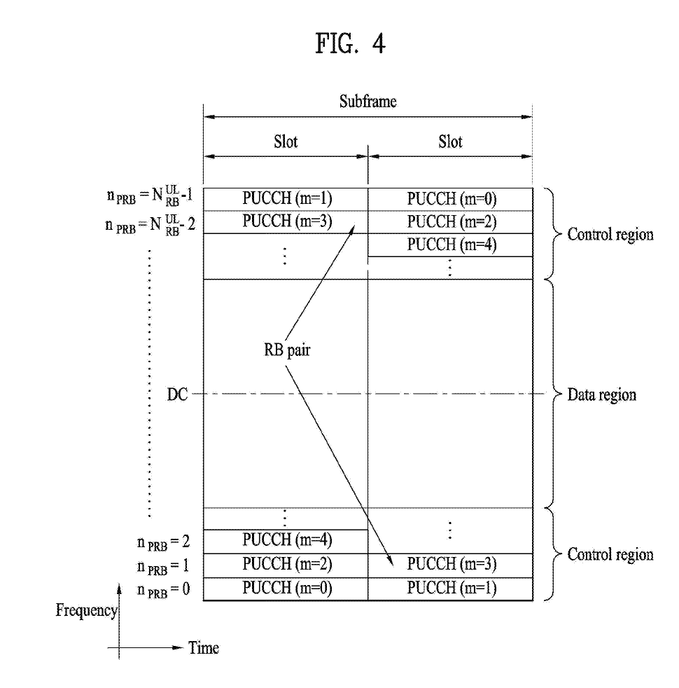

FIG. 4 illustrates an exemplary uplink subframe structure used in 3GPP LTE/LTE-A.

Referring to FIG. 4, a UL subframe can be divided into a control region and a data region in the frequency domain. One or more PUCCHs (physical uplink control channels) can be allocated to the control region to carry uplink control information (UCI). One or more PUSCHs (Physical uplink shared channels) may be allocated to the data region of the UL subframe to carry user data.

In the UL subframe, subcarriers spaced apart from a DC subcarrier are used as the control region. In other words, subcarriers corresponding to both ends of a UL transmission bandwidth are assigned to UCI transmission. The DC subcarrier is a component remaining unused for signal transmission and is mapped to the carrier frequency f0 during frequency up-conversion. A PUCCH for a UE is allocated to an RB pair belonging to resources operating at a carrier frequency and RBs belonging to the RB pair occupy different subcarriers in two slots. Assignment of the PUCCH in this manner is represented as frequency hopping of an RB pair allocated to the PUCCH at a slot boundary. When frequency hopping is not applied, the RB pair occupies the same subcarrier.

The PUCCH can be used to transmit the following control information.
Scheduling Request (SR): This is information used to request a UL-SCH resource and is transmitted using On-Off Keying (OOK) scheme.
HARQ ACK/NACK: This is a response signal to a downlink data packet on a PDSCH and indicates whether the downlink data packet has been successfully received. A 1-bit ACK/NACK signal is transmitted as a response to a single downlink codeword and a 2-bit ACK/NACK signal is transmitted as a response to two downlink codewords. HARQ-ACK responses include positive ACK (ACK), negative ACK (NACK), discontinuous transmission (DTX) and NACK/DTX. Here, the term HARQ-ACK is used interchangeably with the term HARQ ACK/NACK and ACK/NACK.
Channel State Indicator (CSI): This is feedback information about a downlink channel. Feedback information regarding MIMO includes a rank indicator (RI) and a precoding matrix indicator (PMI).

The quantity of control information (UCI) that a UE can transmit through a subframe depends on the number of SC-FDMA symbols available for control information transmission. The SC-FDMA symbols available for control information transmission correspond to SC-FDMA symbols other than SC-FDMA symbols of the subframe, which are used for reference signal transmission. In the case of a subframe in which a sounding reference signal (SRS) is configured, the last SC-FDMA symbol of the subframe is excluded from the SC-FDMA symbols available for control information transmission. A reference signal is used to detect coherence of the PUCCH. The PUCCH supports various formats according to information transmitted thereon.

Table 4 shows the mapping relationship between PUCCH formats and UCI in LTE/LTE-A.

TABLE 4

| | | Number of | | |
|---|---|---|---|---|
| | | bits per | | |
| PUCCH | Modulation | subframe, | | |
| format | scheme | M_{bit} | Usage | Etc. |
| 1 | N/A | N/A | SR (Scheduling | |
| | | | Request) | |
| 1a | BPSK | 1 | ACK/NACK or | One |
| | | | SR + ACK/ | codeword |
| | | | NACK | |
| 1b | QPSK | 2 | ACK/NACK or | Two |
| | | | SR + ACK/ | codeword |
| | | | NACK | |
| 2 | QPSK | 20 | CQI/PMI/RI | Joint coding |
| | | | | ACK/NACK |
| | | | | (extended |
| | | | | CP) |
| 2a | QPSK + | 21 | CQI/PMI/RI + | Normal CP |
| | BPSK | | ACK/NACK | only |
| 2b | QPSK + | 22 | CQI/PMI/RI + | Normal CP |
| | QPSK | | ACK/NACK | only |
| 3 | QPSK | 48 | ACK/NACK or | |
| | | | SR + ACK/ | |
| | | | NACK or | |
| | | | CQI/PMI/RI + | |
| | | | ACK/NACK | |

Referring to Table 4, PUCCH formats 1/1a/1b are used to transmit ACK/NACK information, PUCCH format 2/2a/2b are used to carry CSI such as CQI/PMI/RI and PUCCH format 3 is used to transmit ACK/NACK information.

Reference Signal (RS)

When a packet is transmitted in a wireless communication system, signal distortion may occur during transmission since the packet is transmitted through a radio channel. To correctly receive a distorted signal at a receiver, the distorted signal needs to be corrected using channel information. To detect channel information, a signal known to both a transmitter and the receiver is transmitted and channel information is detected with a degree of distortion of the signal when the signal is received through a channel. This signal is called a pilot signal or a reference signal.

When data is transmitted/received using multiple antennas, the receiver can receive a correct signal only when the receiver is aware of a channel state between each transmit antenna and each receive antenna. Accordingly, a reference signal needs to be provided per transmit antenna, more specifically, per antenna port.

Reference signals can be classified into an uplink reference signal and a downlink reference signal. In LTE, the uplink reference signal includes:

i) a demodulation reference signal (DMRS) for channel estimation for coherent demodulation of information transmitted through a PUSCH and a PUCCH; and

ii) a sounding reference signal (SRS) used for an eNB to measure uplink channel quality at a frequency of a different network.

The downlink reference signal includes:

i) a cell-specific reference signal (CRS) shared by all UEs in a cell;

ii) a UE-specific reference signal for a specific UE only;

iii) a DMRS transmitted for coherent demodulation when a PDSCH is transmitted;

iv) a channel state information reference signal (CSI-RS) for delivering channel state information (CSI) when a downlink DMRS is transmitted;

v) a multimedia broadcast single frequency network (MBSFN) reference signal transmitted for coherent demodulation of a signal transmitted in MBSFN mode; and

vi) a positioning reference signal used to estimate geographic position information of a UE.

Reference signals can be classified into a reference signal for channel information acquisition and a reference signal for data demodulation. The former needs to be transmitted in a wide band as it is used for a UE to acquire channel information on downlink transmission and received by a UE even if the UE does not receive downlink data in a specific subframe. This reference signal is used even in a handover situation. The latter is transmitted along with a corresponding resource by an eNB when the eNB transmits a downlink signal and is used for a UE to demodulate data through channel measurement. This reference signal needs to be transmitted in a region in which data is transmitted.

The present specification proposes a method of defining a subchannel by dividing radio resources in time and frequency domains and a method of forming a physical channel for transmitting information and data by a bundle of subchannels. In particular, a data channel is formed by combining a plurality of subchannels to transmit data.

According to the proposed method, subchannels are used in a manner of being divided between adjacent transmission nodes to minimize mutual interference and an interference amount provided to a subchannel is uniformly maintained to make transmission capacity in each node to be maximized. According to the proposed transmission scheme, a transmission node occupies a resource for a prescribed time in a unit of a subchannel to transmit a signal.

The proposed scheme of the present invention is explained centering on a communication link between an eNB and a UE in a cellular system. Yet, the proposed scheme can be applied to a communication link between UEs as well.

[Definition of Subchannel]

The total radio resources are divided into subchannels (SCs) using a combination of a subband and a subframe in a manner that a transmission band is divided into a plurality of subbands (SBs) and a transmission radio frame is divided into a plurality of subframes (SFs). A subband can be configured by a plurality of subcarriers and a subframe can be configured by a plurality of OFDM symbols in a manner of being combined with OFDM transmission scheme.

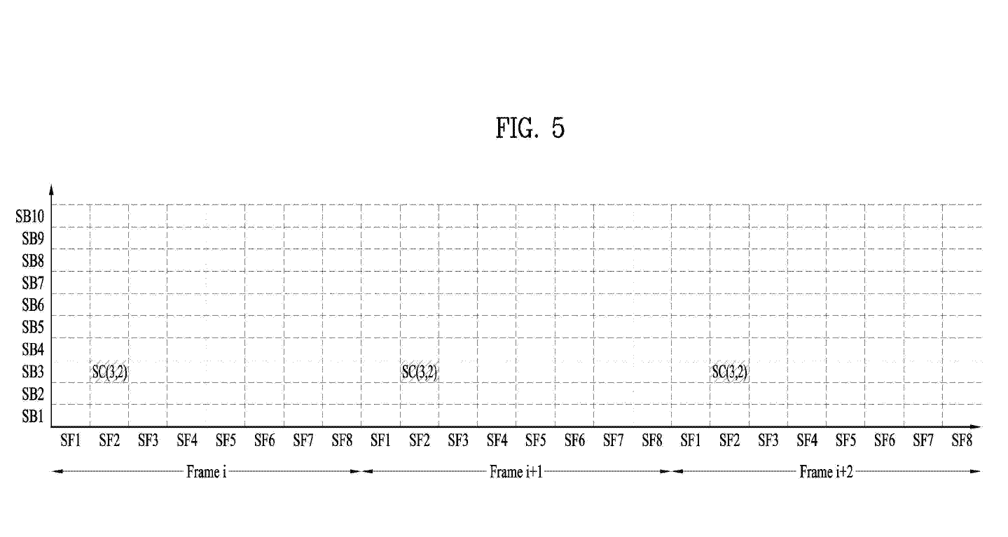

FIG. 5 shows an example that the total radio resources are divided into 80 subchannels using 10 radio transmission bands and 8 radio frames. In FIG. 5, resources represented by a slashed shape correspond to subchannels generated by combining a 3^{rd} subband (SB3) and a 2^{nd} subframe (SF2). In the following, a subchannel generated by combining an i^{th} subband and j^{th} subframe is represented as SC (i,j).

A subchannel structure of an interleaved pattern shown in FIG. 5 has a characteristic capable of easily applying a stop and wait HRAQ operation for data transmission. In FIG. 5, whether a previous data is retransmitted or a new data is transmitted in an (i+1)^{th} frame is determined according to whether or not data transmitted from an i^{th} frame is successfully received. The subchannel structure shown in FIG. 5 enables data transmitted on a subchannel to be managed using a single HARQ process.

[Data Channel and Feedback Channel]

In the following, the present invention is explained in the aspect of DL that data is transmitted from an eNB to a UE in a cellular system.

As a physical channel, it is necessary to have a data channel for transmitting data and a control channel for transmitting control information to indicate a data transmission format. And, in order to send ACK/NACK response for a HARQ operation of the data channel or in order to feedback CQI (channel quality indication) for determining MCS (modulation and coding scheme) of a data channel, it is necessary to have a feedback channel from a receiving node. In case of an FDD system, the feedback channel is transmitted via a reverse direction link located at a different frequency band. In case of a TDD system, the feedback channel is transmitted at a different timing of the same frequency band.

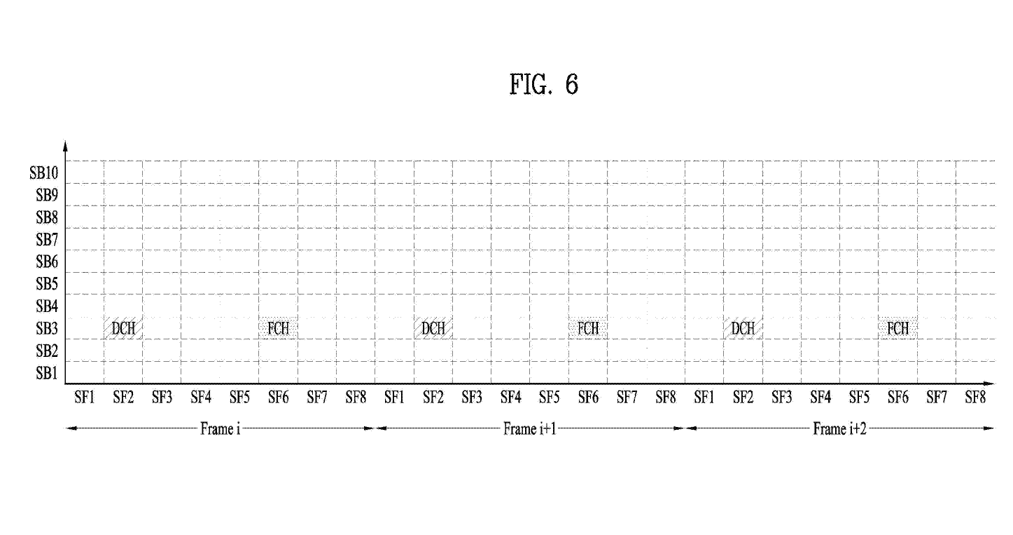

FIG. 6 shows an example that a data channel (DCH) is formed by an SC (3,2) and a feedback channel is formed by an SC (3,6) in a TDD system. In FIG. 6 and following drawings, a control channel is not separately drawn in consideration of a case that the control channel and the data channel are transmitted in a manner of being multiplexed on the same subchannel.

In general, a data mount transmitted on a data channel is considerably larger than an information amount transmitted on a feedback channel. Hence, the number of subchannels for configuring the data channel and the number of subchannels for configuring the feedback channel can be differently configured.

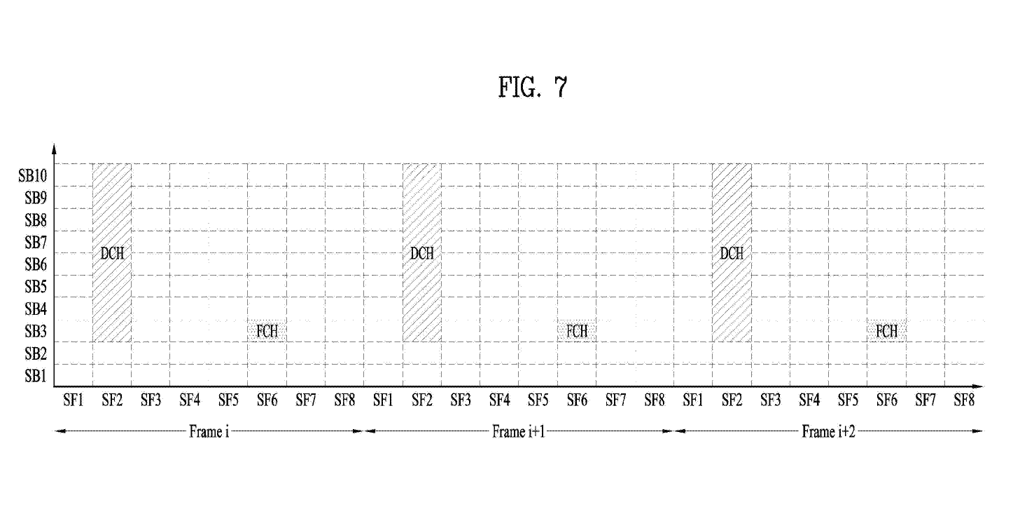

FIG. 7 shows an example that a data channel is formed by 8 subbands including an SC (3,2) to an SC (10,2) and a feedback channel is formed by a single subband SC (3,6) in a TDD system. Unlike the data channel shown in FIG. 7, a data channel can also be configured by subchannels of a discontinuous subband. Moreover, a data channel can also be configured using subchannels over a plurality of subframes.

In order to increase a data transmission rate of a link between an eNB and a UE, it may be able to form a plurality of data channels and transmit data using the same. Each of a plurality of the data channels can be located at a different subband or a different subframe. According to the proposed scheme, a data channel and a feedback channel are configured to make a pair.

A transmission timing of a data channel and a transmission timing of a feedback channel can be defined with a predetermined difference. In particular, if the data channel is transmitted in an n^{th} subframe, the feedback channel can be fixed to respond in an (n+d)^{th} subframe.

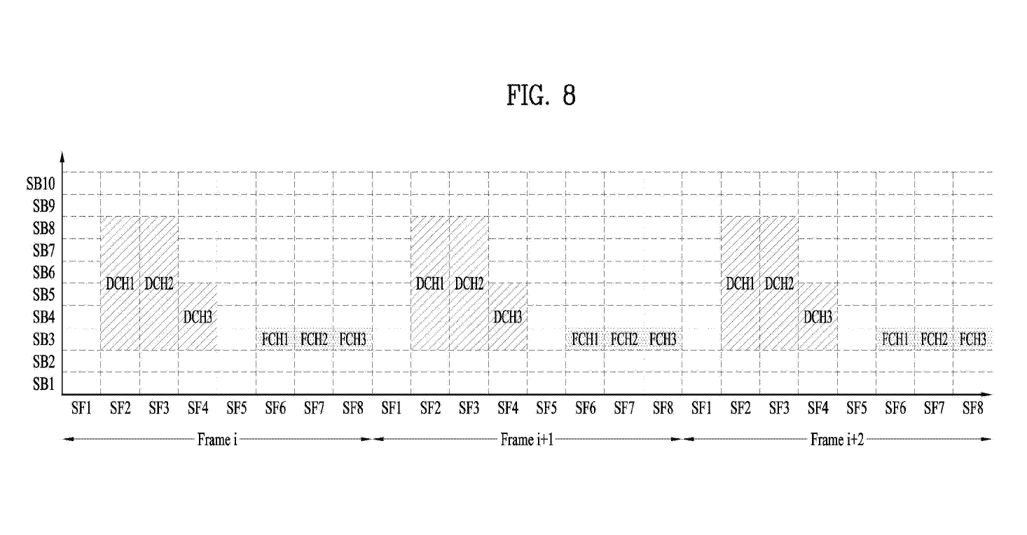

FIG. 8 shows an example for a case that a feedback channel is fixed to respond in an (n+4)^{th} subframe in response to a data channel which is transmitted in an n^{th} subframe in a TDD system. According to an embodiment of the present invention, 3 data channels are set to a corresponding link to transmit data. In the drawing, a UE makes a response by a feedback channel FCH1 in a 6^{th} subframe in response to a data channel DCH1 which is transmitted in a 2^{nd} subframe. And, the UE makes a response by a feedback channel FCH2 in a 7^{th} subframe in response to a data channel DCH2 which is transmitted in a 3^{rd} subframe. According to the embodiment of the present invention, an independent HARQ process is managed in each data channel. In particular, assume that there exist 3 HARQ processes in total. Since it is able to independently configure subbands that construct each data channel, in case of a data channel DCH3, the data channel may have a narrower transmission band compared to data channels DCH1 and the DCH2.

Referring to FIG. 8, since a scheme of utilizing a fixed space between a data channel and a feedback channel uses only the half of total subframes in transmitting data channels in a TDD system, the scheme has a demerit in that a data transmission efficiency is low. However, since a fixed space is able to definitely guarantee time required for reception processing such as data channel decoding of a UE, and the like and time required for transmission processing of an eNB, it may have a merit in that implementation is easy. Hence, the scheme of utilizing a fixed space between a data channel and a feedback channel has the great advantage especially in a FDD system.

When a data channel is configured, it may consider a variable scheme that configures a relative position of a feedback channel. An eNB designates subchannels used as a feedback channel of a UE while informing the UE of subchannels used as a data channel. In order to make the UE easily implement reception processing, it may be able to set a limit on subchannel positions to which a feedback channel is configurable.

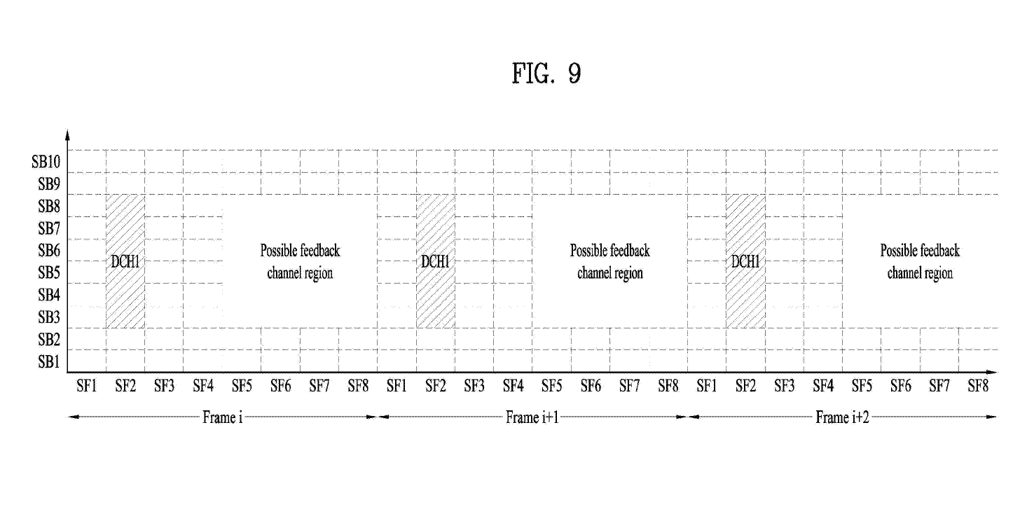

FIG. 9 shows an example of a resource region of a feedback channel capable of being configured in response to a resource position of a data channel in the variable scheme. Referring to FIG. 9, a feedback channel is transmitted in an (n+d)^{th} subframe in response to a data channel transmitted in an n^{th} subframe. In this case, the d can be selected from among 3, 4, 5, and 6. A minimum value of the space d between the data channel and the feedback channel should be configured to be larger than time required for a receiver to perform reception processing such as data channel decoding and the like. A maximum value of the space d should be configured in consideration of time required for a transmitter to receive ACK/NACK feedback and time required for the transmitter to prepare data transmission. The embodiment of FIG. 9 shows an available region of a feedback channel when the receiver requires minimum 2 subframes for reception processing and the transmitter requires minimum 1 subframe for transmission processing.

A subband on which a feedback channel is transmitted is designated within a determined range. This is intended to configure the feedback channel within a maximum bandwidth capable of being supported by a transmitter. In particular, if there is a limit on a reception bandwidth due to capability of a UE, the number of subbands of a data channel set to the UE is configured to be set within a bandwidth capable of being maximally supported. As a result, a location to which the feedback channel is set is configured to be set within the bandwidth.

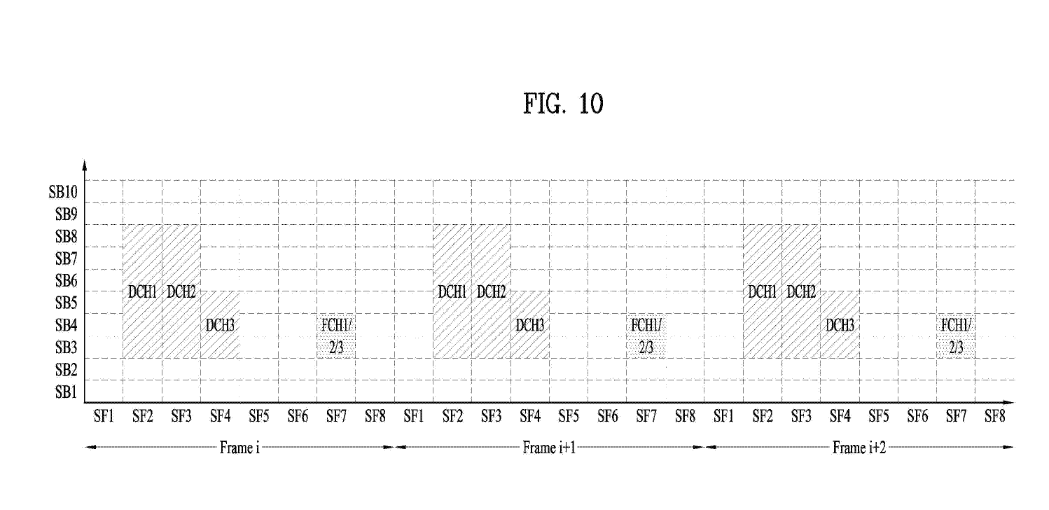

FIG. 10 shows a case that 3 data channels are set to a corresponding link to transmit data in a variable scheme. FIG. 10 shows an example that a resource of a feedback channel corresponding to each data channel is matched to transmit feedback channels FCH1, FCH2, and FCH3 on the same subchannel in a manner of multiplexing the feedback channels. In FIG. 10, a space d between a data channel DCH1 and a feedback channel FCH1 is configured by 5, a space d between a data channel DCH2 and a feedback channel FCH2 is configured by 4, and a space d between a data channel DCH3 and a feedback channel FCH3 is configured by 3. As shown in the embodiment of FIG. 9, if there is a limit on a range of the space d, maximum 75% of the total subframes can be used for transmitting data channel in a TDD system.

If a frame is divided into N number of subframes and each subchannel repeatedly appears in every N number of subframes, a space d between a data channel and a feedback channel should be configured to be smaller than N. However, this constraint may limit flexibility of resource utilization in a TDD system. Hence, the present invention proposes a method of managing a case that the space d is greater than the N.

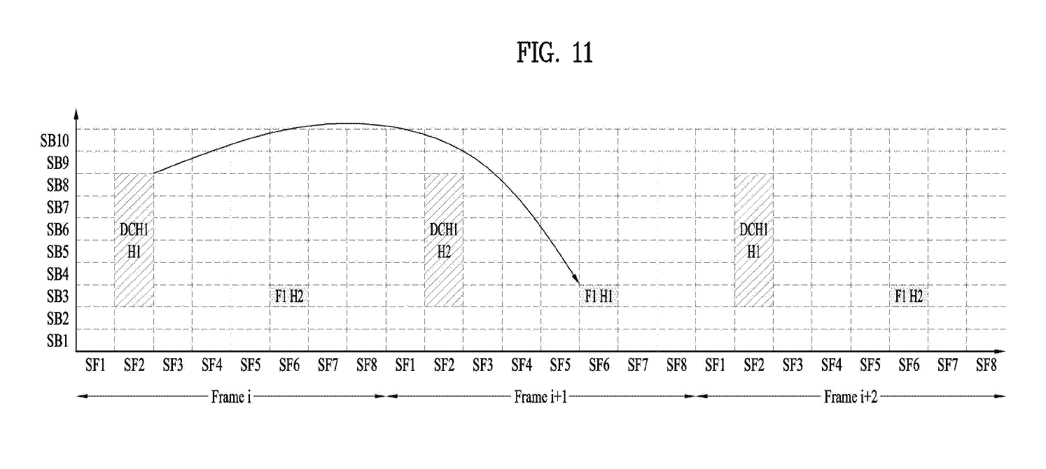

FIG. 11 shows a method of managing a single data channel by two HARQ processes. According to the proposed method, a data channel is managed by two HARQ processes in a manner of being divided into a HARQ process 1 and a HARQ process 2. Referring to the example shown in FIG. 11, ACK/NACK feedback is transmitted in an SF6 of (i+1)^{th} frame appearing after d=12 subframe in response to data transmitted in an SF2 of an i^{th} frame. In the example, if a receiver fails to properly decode the data transmitted in the SF2 of the i^{th} frame, the data is retransmitted in an SF2 of (i+2)^{th} frame.

According to the proposed scheme, if a feedback channel is configured within a feedback channel resource region (i.e., if d is designated between 3 and 6), a single data channel is managed by a single HARQ process. If the d is designated between 7 and 14, a single data channel is managed by two HARQ processes. If the space d is equal to or greater than 14, a single data channel is managed by two or more HARQ processes.

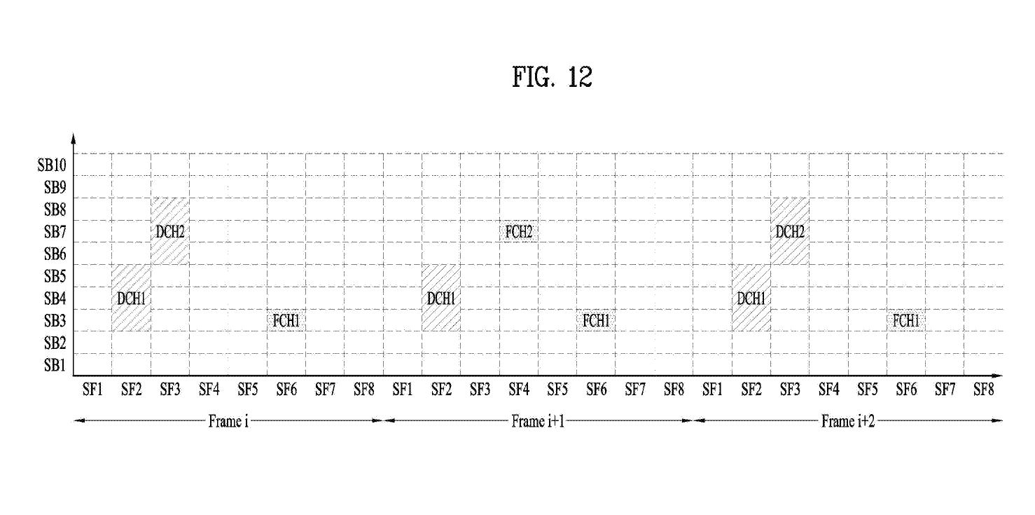

As a different management method, FIG. 12 shows a method that a transmission interval of a data channel is selected from among N and 2N. According to the proposed method, the transmission interval of the data channel can be adjusted according to the space d between the data channel and the feedback channel. If a feedback channel is configured within a feedback channel resource region shown in FIG. 9 (i.e., if d is designated between 3 and 6), a data channel is transmitted in every N number of subframes. If the d is designated between 7 and 14, a data channel is transmitted in every 2N number of subframes. In a broad sense, if the d is equal to or greater than 14, a data channel is transmitted in every N multiple number of subframes. This management scheme is identical to the method of forming a data channel according to a HARQ process mentioned in FIG. 11.

[Grant Channel and Data Channel]

In the following, a method of dividing radio resources is explained in the aspect of UL (uplink) that data is transmitted from a UE to an eNB in a cellular system. It may be able to consider two procedures for transmitting UL data.

A first procedure corresponds to a scheme that a UE determines a data amount, a transmission format such as MCS, and the like to transmit data. In this case, the UE transmits a control channel together with a data channel. And, an eNB transmits ACK/NACK information and CQI information on a feedback channel in response to the data channel and the control channel. This procedure is identical to a case that a UE plays a role of an eNB and the eNB plays role of the UE in DL transmission scheme. Hence, the DL embodiments shown in FIG. 6 to FIG. 12 can be applied to UL as it is.

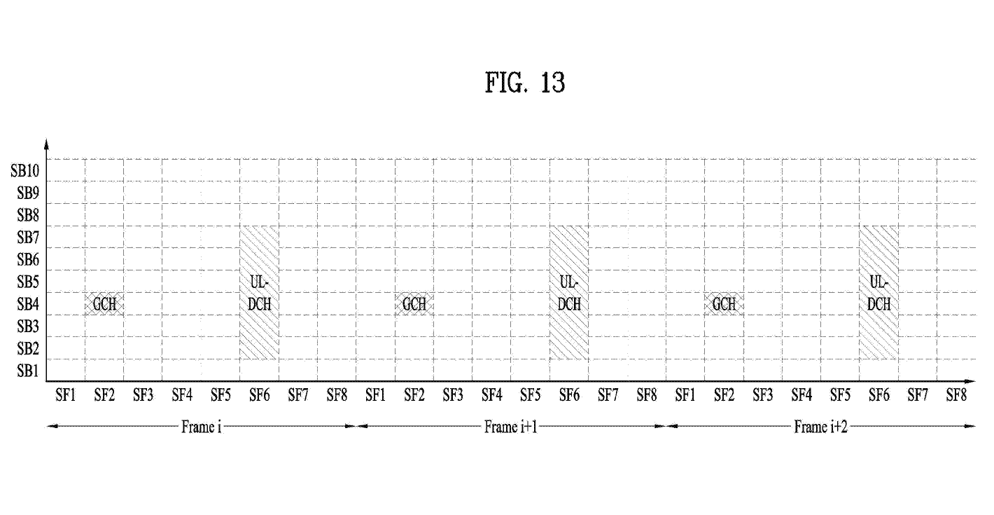

Meanwhile, a second procedure corresponds to a scheme that an eNB determines whether to transmit UL data and a transmission format and informs a UE of a result of the determination. The eNB informs the UE of a data amount, a UL data transmission format such as MCS, and the like, and information on whether or not ACK/NACK is transmitted in response to a previously transmitted data. By doing so, the eNB can indicate the UE to retransmit the previous data or transmit a new data. FIG. 13 shows an embodiment that the eNB forwards information on whether or not the UE transmits data and format information to the UE via a grant channel and the UE transmits a data channel in a predetermined resource based on the information received from the eNB.

Similar to DL, in order to increase a data transmission rate in UL, a plurality of data channels are formed on a link between a UE and an eNB and the UE transmits data using the data channels. Each of a plurality of the data channels can be located at a different subband or a different subframe. According to the proposed scheme, a grant channel and a data channel are configured to make a pair.

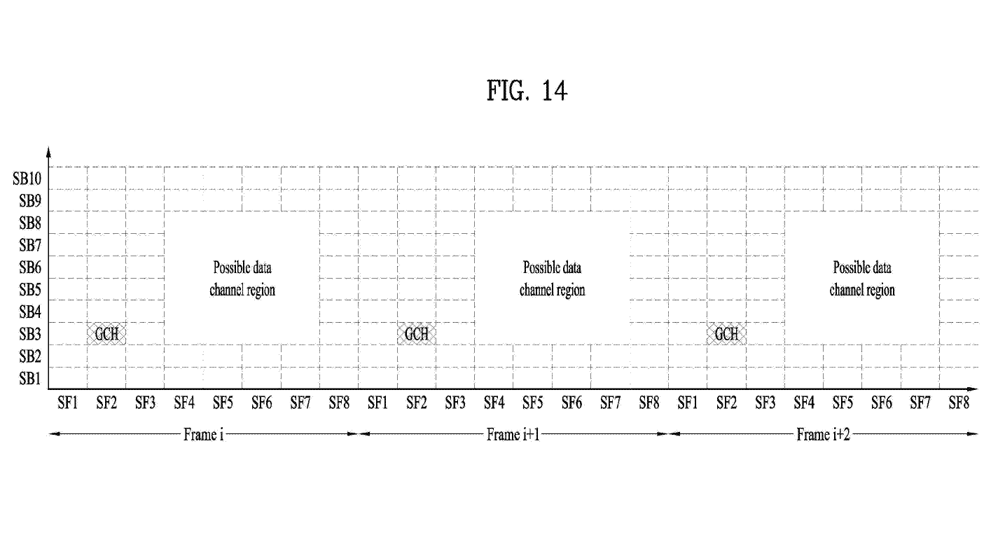

A transmission timing of a grant channel and a transmission timing of a data channel can be defined by a fixed space scheme for defining the timings with a predetermined difference or a variable space scheme for defining the timings with a space between two channels. According to the fixed space scheme, a data channel is transmitted in (n+d)^{th} subframe in response to a grant channel which is transmitted in an n^{th} subframe. In this case, the d is defined in advance to make a fixed space exist between all pairs of the grant channel and the data channel. According to the variable space scheme, when a data channel is configured, a relative position compared to grant channel transmission timing can be selected from among available values to configure the data channel. FIG. 14 shows an example of a resource region of a data channel capable of being configured in relation to a resource position of a grant channel in the variable space scheme. In FIG. 14, a data channel is transmitted in (n+d)^{th} subframe according to indication of a grant channel transmitted in an n^{th} subframe. In this case, the d can be designated from among 2, 3, 4 and 5. The embodiment of FIG. 14 shows a region capable of transmitting a data channel when a UE requires minimum 1 subframe for data transmission processing after a grant channel is received and an eNB requires minimum 2 subframes for data reception processing.

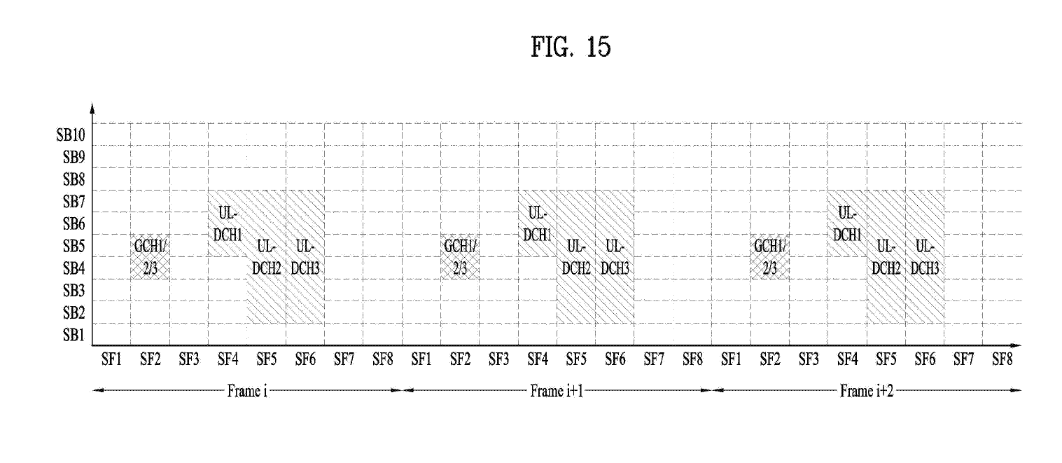

FIG. 15 illustrates a case that 3 data channels are set to a corresponding link to transmit data in a variable scheme. FIG. 15 shows an example that a resource of a grant channel corresponding to each data channel is matched to transmit grant channels GCH1, GCH2, and GCH3 on the same subchannel in a manner of multiplexing the grant channels. In FIG. 15, a space d of a data channel DCH1 is configured by 2, a space d of a data channel DCH2 is configured by 3, and a space d of a data channel DCH3 is configured by 4 in comparison with a grant channel.

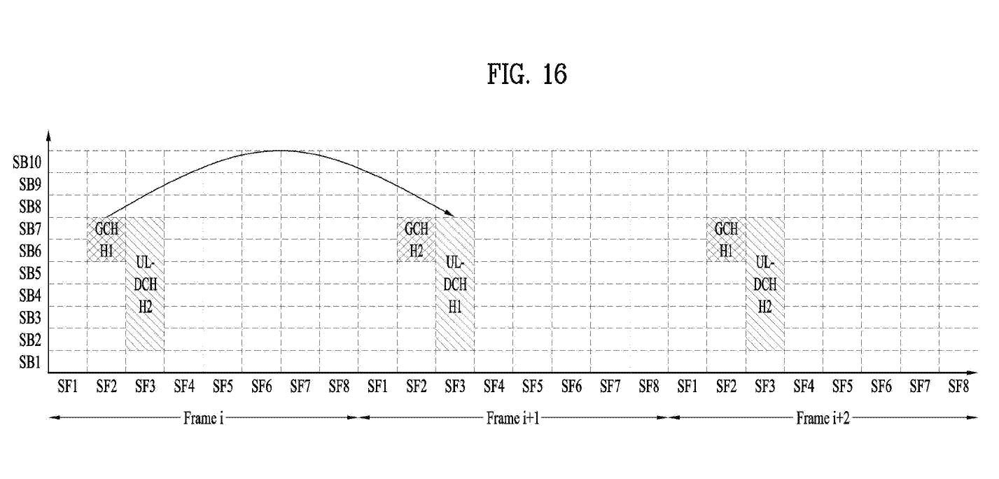

If each subchannel is configured to repeatedly appear in every N number of subframes, a space d between a grant channel and a data channel should be configured to be smaller than N. However, this constraint may limit flexibility of resource utilization in a TDD system. Hence, if the space d is greater than N, as shown in FIG. 16, it may be able to use a scheme of managing a single data channel by two HARQ processes. Referring to an example of FIG. 16, for instance, data is transmitted in an SF3 of (i+1)^{th} frame appearing after d=9 subframe in response to a grant of HARQ process 1 transmitted in an SF2 of an i^{th} frame. Consequently, the method proposed in the present embodiment is identical to a method of defining a data channel according to a HARQ process and selecting a transmission interval of the data channel from among N and 2N.

[Common Data Channel and Dedicated Data Channel]

Data channels can be divided into a common data channel and a dedicated data channel. In order to transceive small amount of data between an eNB and a UE, it may use a common data channel. In order to transceive large amount of data between the eNB and the UE, it may configure a dedicated data channel and can transmit the data via the dedicated data channel. Basically, a common channel is configured between the eNB and the UE. If a data amount to be transmitted increases, information for configuring a dedicated data channel is transmitted to the UE via the common channel.

The information for configuring the dedicated data channel can include the number of data channels, the number of subchannels included in each data channel, and a resource position. In case of DL, the information can include the number of subchannels included in a feedback channel corresponding to each data channel and a resource position. In case of UL, the information can include the number of subchannels included in a grant channel corresponding to each data channel and a resource position. When a configuration of the dedicated data channel is changed, it may change the configuration of the dedicated data channel via a common data channel or a predetermined dedicated data channel.

In case of DL, a common data channel may correspond to a channel at which a UE receiving forwarded data changes. Hence, a control channel, which is transmitted together with the common data channel in every subframe, includes information on a UE to which the data is forwarded. On the contrary, in case of a DL dedicated data channel, when the DL dedicated channel is configured, a UE to be used for the DL dedicated channel is determined. Hence, it is not necessary to include information on the UE in a control channel which is transmitted together with the dedicated data channel.

In case of UL, a common data channel may correspond to a channel at which a UE transmitting data changes. Hence, a grant channel, which is connected with the common data channel, includes information on a UE to transmit data using the common data channel. On the contrary, in case of a UL dedicated data channel, when the UL dedicated data channel is configured, a UE to be used for the UL dedicated data channel is determined. Hence, it is not necessary to designate a UE to transmit data using the grant channel.

In case of a common data channel, a UE using the channel may change whenever data is transmitted. If there is no UE to use the common data channel, no signal is transmitted on the channel. Hence, in the aspect of a neighboring eNB on subchannels constructing the common data channel, an interference amount is not fixed. On the contrary, a dedicated data channel is seamlessly used for transmitting data from the start of configuration to the end of the configuration of the dedicated data channel. In this case, in the aspect of a neighboring eNB on subchannels constructing the dedicated data channel, an interference amount is uniformly maintained, thereby increasing adaptation efficiency of a transmission data rate.

In order to evenly maintain an interference amount provided to a neighboring cell, a dedicated data channel can be configured only when data are continuously transmitted more than prescribed times on subchannels or when data are sufficiently buffered in a transmission buffer to continuously use a corresponding resource for more than prescribed time. If there is no data to be transmitted anymore and no signal is transmitted on a subchannel, the configuration of the dedicated data channel is released.

An eNB determines a region to be used for a common channel and a region to be used for a dedicated channel in advance among total radio resources, i.e., subchannels. The eNB informs a neighboring eNB of the determined regions.

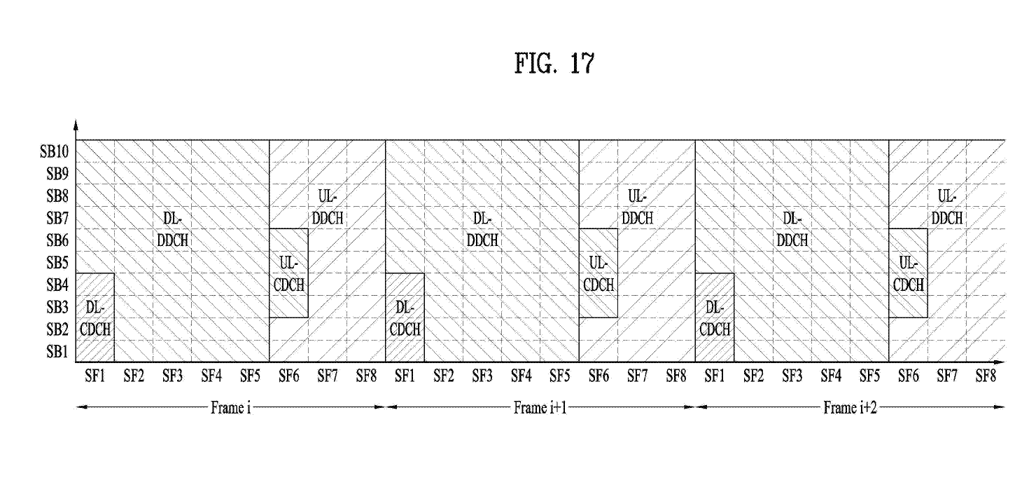

FIG. 17 shows an example that a radio resource is divided into a region for a DL common data channel (DL-CDCH), a region for a DL dedicated data channel (DL-DDCH), a region for a UL common data channel (UL-CDCH), and a region for a UL dedicated data channel (UL-DDCH). In FIG. 17, a feedback channel is not separately drawn under the assumption that the feedback channel uses the UL-CDCH region when the feedback channel makes a pair with a common data channel and uses subchannels of the UL-DDCH region when the feedback channel makes a pair with a dedicated data channel. Similarly, a grant channel is not separately drawn under the assumption that the grant channel uses the DL-CDCH region when the grant channel makes a pair with a common data channel and uses subchannels of the DL-DDCH region when the grant channel makes a pair with a dedicated data channel.

As a variation, a resource size of a common data channel can be defined in advance. A corresponding position can be informed only between eNBs. And, a resource position of UL-CDCH can be defined in advance based on a positon of DL-CDCH.

An object of the proposed scheme is to inform a neighboring eNB of a region at which interference provided to the neighboring eNB is uniformly maintained and a region at which an interference amount is changed at every transmission timings, respectively. In particular, the object of the proposed scheme is to inform the neighboring eNB of a region at which signal transmission is evenly maintained for prescribed time and a region at which a direction of a transmission beam is not maintained in MIMO transmission, respectively. Hence, it may be able to directly inform the neighboring eNB of a region at which transmission is constantly performed and a region at which transmission is irregularly performed, respectively, instead of informing the neighboring eNB of positions to which a common channel and a dedicated channel are set.

In addition, a resource region of a dedicated data channel can be divided into a plurality of regions. In this case, it may be able to inform a neighboring eNB of use priority of each of a plurality of the regions. A subchannel of high priority can be assigned first as a dedicated data channel. The neighboring eNB can determine whether or not a resource position is interfered by interference based on the additional information. If each cell does not use the total radio resources due to low loading in each cell, inter-cell interference can be minimized by making a mutually used radio resource not to be overlapped between cells. By doing so, it is able to efficiently control the inter-cell interference.

In order to control the inter-cell interference, information is exchanged between eNBs via a wired or wireless backhaul. If there is a limit on an information amount exchanged via the wired/wireless backhaul, it may be able to exchange attributes of the aforementioned common data channel region, the dedicated data channel region, and the priority of each region. Meanwhile, if speed of the information exchanged via the wired/wireless backhaul is very fast, it may be able to configure a dedicated data channel and inform a neighboring eNB of the dedicated data channel in real time. Or, if the information exchanged via the backhaul has a delay in some extent, configuration expectation information on a dedicated data channel can be transmitted to a neighboring eNB together with information on expectation timing.

[Listen Before Occupy]

In the present paragraph, a method of controlling interference using an LBO (listen before occupy) operation is proposed when information exchange for controlling inter-cell interference via backhaul between eNBs is impossible. According to the proposed method, each eNB measures an interference amount or a signal transmitted from a neighboring cell on subchannels capable of being selected by the eNB to configure a dedicated data channel. Subsequently, the eNB selects subchannels for constructing a dedicated data channel according to a measurement result. As an embodiment, the eNB measures an interference amount from each subchannel to configure a data channel using a subchannel of less interference amount. Or, the eNB may randomly select a subchannel from among subchannels that an interference amount is equal to or less than a prescribed level or subchannels that a signal transmitted from a neighboring cell is received with a level equal to or less than a specific level to configure a data channel.

For an initial access or handover of a UE in a general cellular system, an eNB transmits a synchronization signal and a measurement signal. In the present invention, the synchronization signal and the measurement signal can also be transmitted using a part of a resource region of a DL common data channel. According to the proposed method, when an eNB is turned on, the eNB receives a synchronization signal and a measurement signal from a neighboring eNB, matches time synchronization with the neighboring eNB, and identifies a position of the DL common data channel of the neighboring eNB. And, the eNB determines a transmission resource position of the DL common data channel in consideration of positions of DL common data channel resources of neighboring eNBs. In this case, a position of a UL common data channel resource can be predefined to be known from the position of the DL common data channel resource. And, sizes of the DL and UL common data channel resources can be defined in advance.

Unlikely, when system information is informed via a broadcast channel of the DL common data channel, the positions and the sizes of the DL and the UL common data channel resources can be informed. In this case, it is able to know a position and a size of a common channel by receiving system information of a neighboring eNB.

[CSI Feedback]

According to the proposed scheme, since each cell uses a radio resource in a subchannel unit, there may exist a difference in an interference amount according to a subchannel. In particular, a difference in reception quality between data channels is represented according to a subchannel due to a difference between interference amounts. In order to obtain optimized transmission capacity in the aforementioned environment, CQI is fed back according to a subchannel and a transmission MCS can be controlled according to a subchannel. In order to differentiate the MCS according to a subchannel, data to be transmitted are divided according to a subchannel and coding and rate matching are differentiated according to each data block to transmit data according to an MCS selected on a corresponding subchannel. Meanwhile, it may be able to feedback CQI according to a data channel and control a transmission MCS in consideration of overhead of control information and feedback information.

CSI including CQI is transmitted on a feedback channel together with ACK/NACK. In order to reduce feedback overhead, it may be able to report a difference of an MCS level capable of being supported in consideration of CQI compared to an MCS level which is used in a previous transmission together with ACK/NACK for the previous data transmission. Table 5 shows an example that ACK/NACK and CQI are fed back in a manner of being combined to differently interpret CQI information according to ACK/NACK.

TABLE 5

| HARQ-ACK bundled | | |
|---|---|---|
| with CQI feedback | A/N | CQI |
| 00 | A | Request to keep MCS |
| 01 | A | Request to increase MCS |
| 10 | N | Request to keep MCS |
| 11 | N | Request to decrease MCS |

[UE Capability]

According to the proposed scheme, a UE can inform an eNB of following items as UE capability.
Number of data channels capable of being supported at the same time
Maximum supportable bandwidth
Maximum number of subchannels constructing data channel
Maximum number of bits capable of being transmitted per data channel

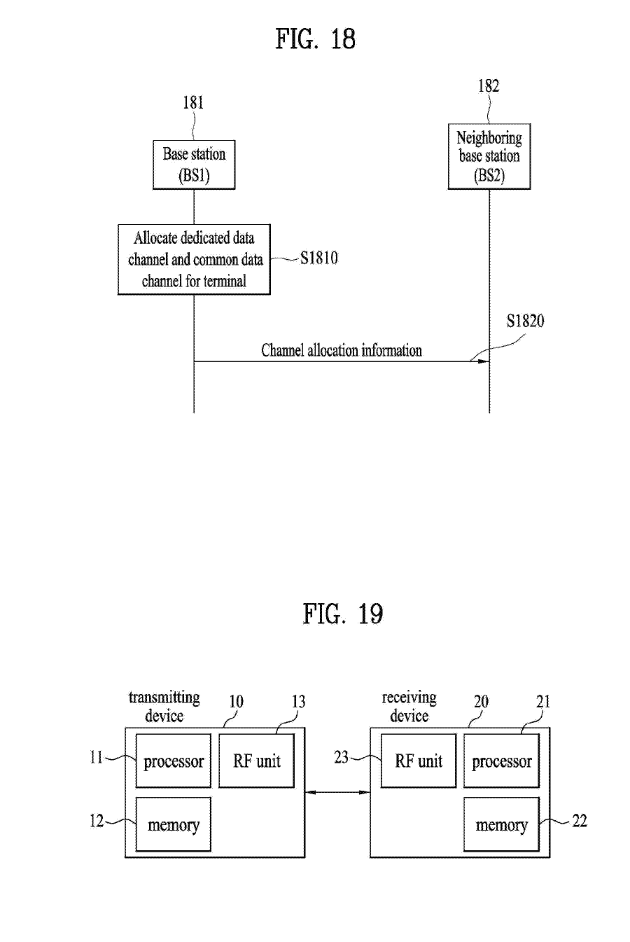

FIG. 18 is a flowchart for an operation according to one embodiment of the present invention.

FIG. 18 relates to a method of controlling interference in a radio resource consisting of a plurality of bands and a plurality of frames.

An eNB 181 can allocate a dedicated data channel for a specific UE and a common data channel for a plurality of UEs [S1810]. The eNB can forward information on the allocated dedicated data channel and the common data channel to a neighboring eNB 182 [S1820]. The dedicated data channel can be allocated when data to be transmitted to the specific UE, which is standing by in a transmission buffer, is greater than a predetermined amount.

The information on the dedicated data channel can include the number of the dedicated data channel, the number of subchannels included in each dedicated data channel, and a resource position of each dedicated data subchannel.

The information on the dedicated data channel can include the number of subchannels included in a feedback channel or a grant channel connected with each dedicated data channel and a resource position of each dedicated feedback subchannel.

The number of HARQ (hybrid automatic request transmission) processes of the dedicated data channel can be determined according to a space between the dedicated data channel and a feedback channel or a grant channel associated with the dedicated data channel.

A transmission interval of the dedicated data channel can be determined according to a time interval between the dedicated data channel and a feedback channel or a grant channel associated with the dedicated data channel.

A plurality of feedback channels or grant channels associated with a plurality of dedicated data channels can be assigned to a single subchannel in a manner of being multiplexed.

The eNB 181 can forward information on use priority of a plurality of subchannels constructing the dedicated data channel to the neighboring eNB 182. The eNB can allocate the dedicated data channel according to the use priority.

The eNB 181 can receive information on a dedicated data channel and a common data channel allocated for UEs of the neighboring eNB from the neighboring eNB 182.

The dedicated data channel allocated for the specific UE and the common data channel allocated for a plurality of the UEs can be allocated based on the information on the dedicated data channel and the common data channel allocated for the UEs of the neighboring eNB received from the neighboring eNB.

The operation of the UE or the eNB shown in FIG. 18 can include not only the embodiment mentioned earlier with reference to FIG. 18, but also at least one of the aforementioned embodiments of the present invention.

FIG. 19 is a block diagram of a transmitting device 10 and a receiving device 20 configured to implement exemplary embodiments of the present invention. Referring to FIG. 19, the transmitting device 10 and the receiving device 20 respectively include radio frequency (RF) units 13 and 23 for transmitting and receiving radio signals carrying information, data, signals, and/or messages, memories 12 and 22 for storing information related to communication in a wireless communication system, and processors 11 and 21 connected operationally to the RF units 13 and 23 and the memories 12 and 22 and configured to control the memories 12 and 22 and/or the RF units 13 and 23 so as to perform at least one of the above-described embodiments of the present invention.

The memories 12 and 22 may store programs for processing and control of the processors 11 and 21 and may temporarily storing input/output information. The memories 12 and 22 may be used as buffers. The processors 11 and 21 control the overall operation of various modules in the transmitting device 10 or the receiving device 20. The processors 11 and 21 may perform various control functions to implement the present invention. The processors 11 and 21 may be controllers, microcontrollers, microprocessors, or microcomputers. The processors 11 and 21 may be implemented by hardware, firmware, software, or a combination thereof. In a hardware configuration, Application Specific Integrated Circuits (ASICs), Digital Signal Processors (DSPs), Digital Signal Processing Devices (DSPDs), Programmable Logic Devices (PLDs), or Field Programmable Gate Arrays (FPGAs) may be included in the processors 11 and 21. If the present invention is implemented using firmware or software, firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 10 is scheduled from the processor 11 or a scheduler connected to the processor 11 and codes and modulates signals and/or data to be transmitted to the outside. The coded and modulated signals and/or data are transmitted to the RF unit 13. For example, the processor 11 converts a data stream to be transmitted into K layers through demultiplexing, channel coding, scrambling and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the RF unit 13 may include an oscillator. The RF unit 13 may include Nt (where Nt is a positive integer) transmit antennas.

A signal processing process of the receiving device 20 is the reverse of the signal processing process of the transmitting device 10. Under the control of the processor 21, the RF unit 23 of the receiving device 10 receives RF signals transmitted by the transmitting device 10. The RF unit 23 may include Nr receive antennas and frequency down-converts each signal received through receive antennas into a baseband signal. The RF unit 23 may include an oscillator for frequency down-conversion. The processor 21 decodes and demodulates the radio signals received through the receive antennas and restores data that the transmitting device 10 wishes to transmit.

The RF units 13 and 23 include one or more antennas. An antenna performs a function of transmitting signals processed by the RF units 13 and 23 to the exterior or receiving radio signals from the exterior to transfer the radio signals to the RF units 13 and 23. The antenna may also be called an antenna port. Each antenna may correspond to one physical antenna or may be configured by a combination of more than one physical antenna element. A signal transmitted through each antenna cannot be decomposed by the receiving device 20. A reference signal (RS) transmitted through an antenna defines the corresponding antenna viewed from the receiving device 20 and enables the receiving device 20 to perform channel estimation for the antenna, irrespective of whether a channel is a single RF channel from one physical antenna or a composite channel from a plurality of physical antenna elements including the antenna. That is, an antenna is defined such that a channel transmitting a symbol on the antenna may be derived from the channel transmitting another symbol on the same antenna. An RF unit supporting a MIMO function of transmitting and receiving data using a plurality of antennas may be connected to two or more antennas.

In embodiments of the present invention, a UE serves as the transmission device 10 on uplink and as the receiving device 20 on downlink. In embodiments of the present invention, an eNB serves as the receiving device 20 on uplink and as the transmission device 10 on downlink.

The transmitting device and/or the receiving device may be configured as a combination of one or more embodiments of the present invention.

It will be apparent to those skilled in the art that various modifications and variations can be made in the present invention without departing from the scope of the inventions. Thus, it is intended that the present invention covers the modifications and variations of this invention provided they come within the scope of the appended claims and their equivalents.

### INDUSTRIAL APPLICABILITY

The present invention is applicable to a wireless communication device such as a mobile terminal, relay, or base station.

What is claimed is:

1. A method of controlling interference in a radio resource comprised of a plurality of bands and a plurality of frames, comprising:
allocating a dedicated data channel for a specific terminal and a common data channel for a plurality of terminals; and
forwarding information on the allocated dedicated data channel and the common data channel to a neighboring base station,
wherein the dedicated data channel is allocated when an amount of data to be transmitted to the specific terminal, which is waiting in a transmission buffer, is greater than a predetermined amount.

2. The method of claim 1, wherein the information on the dedicated data channel comprises the number of the dedicated data channel, the number of subchannels contained in each dedicated data channel, and a resource position of each dedicated data subchannel.

3. The method of claim 2, wherein the information on the dedicated data channel comprises the number of subchannels contained in a feedback channel or a grant channel linked with each dedicated data channel and a resource position of each dedicated feedback subchannel.

4. The method of claim 3, wherein the number of HARQ (hybrid automatic request transmission) processes of the dedicated data channel is determined according to a time interval between the dedicated data channel and the feedback channel or the grant channel linked with the dedicated data channel.

5. The method of claim 3, wherein a transmission interval of the dedicated data channel is determined according to a time interval between the dedicated data channel and the feedback channel or the grant channel linked with the dedicated data channel.

6. The method of claim 2, wherein a plurality of feedback channels or grant channels associated with a plurality of dedicated data channels are multiplexed and allocated to a single subchannel.

7. The method of claim 1, further comprising forwarding, to the neighboring base station, information on an use priority of a plurality of sub-regions contained in the dedicated data channel,
wherein the dedicated data channel is allocated according to the use priority.

8. The method of claim 1, further comprising receiving information on a dedicated data channel and a common data channel allocated for terminals of the neighboring base station from the neighboring base station.

9. The method of claim 1, wherein the dedicated data channel for the specific terminal and the common data channel for the plurality of the terminals are allocated based on information on a dedicated data channel and a common data channel allocated for terminals of the neighboring base station received from the neighboring base station.

10. A base station configured to control interference in a radio resource comprised of a plurality of bands and a plurality of frames, comprising:
an RF (radio frequency) unit; and
a processor configured to control the RF unit, the processor configured to allocate a dedicated data channel for a specific terminal and a common data channel for a plurality of terminals, the processor configured to forward information on the allocated dedicated data channel and the common data channel to a neighboring base station,
wherein the dedicated data channel is allocated when an amount of data to be transmitted to the specific terminal, which is waiting in a transmission buffer, is greater than a predetermined amount.

11. The base station of claim 10, wherein the information on the dedicated data channel comprises the number of the dedicated data channel, the number of subchannels contained in each dedicated data channel, and a resource position of each dedicated data subchannel.

12. The base station of claim 11, wherein the information on the dedicated data channel comprises the number of subchannels contained in a feedback channel or a grant channel linked with each dedicated data channel and a resource position of each dedicated feedback subchannel.

13. The base station of claim 12, wherein the number of HARQ (hybrid automatic request transmission) processes of the dedicated data channel is determined according to a time interval between the dedicated data channel and the feedback channel or the grant channel linked with the dedicated data channel.

14. The base station of claim 12, wherein a transmission interval of the dedicated data channel is determined according to a time interval between the dedicated data channel and the feedback channel or the grant channel linked with the dedicated data channel.

15. The base station of claim 11, wherein a plurality of feedback channels or grant channels associated with a plurality of dedicated data channels are multiplexed and allocated to a single subchannel.

16. The base station of claim 10, wherein the processor is configured to forward, to the neighboring base station, information on an use priority of a plurality of sub-regions contained in the dedicated data channel to the neighboring base station and wherein the dedicated data channel is allocated according to the use priority.

17. The base station of claim 10, wherein the processor is configured to receive information on a dedicated data channel and a common data channel allocated for terminals of the neighboring base station from the neighboring base station.

18. The base station of claim 10, wherein the dedicated data channel for the specific terminal and the common data channel for the plurality of the terminals are allocated based on information on a dedicated data channel and a common data channel allocated for terminals of the neighboring base station received from the neighboring base station.
